(19) United States
(12) Patent Application Publication
(10) Pub. No.: US 2025/0142449 A1
(43) Pub. Date: May 1, 2025

(54) CENTRALIZED COUNTING IN MULTI SERVICE AREAS

(71) Applicant: TELEFONAKTIEBOLAGET LM ERICSSON (PUBL), Stockholm (SE)

(72) Inventors: George FOTI, DOLLARD DES ORMEAUX (CA); Peter HEDMAN, HELSINGBORG (SE)

(21) Appl. No.: 18/838,667

(22) PCT Filed: Mar. 7, 2023
(86) PCT No.: PCT/IB2023/052153

§ 371 Date: Aug. 15, 2024

Related U.S. Application Data
(60) Provisional application No. 63/319,440, filed on Mar. 14, 2022.

(51) Int. Cl. H04W 48/06; H04W 48/18

(52) U.S. Cl. CPC H04W 48/06; H04W 48/18

(57) ABSTRACT

Methods, system and apparatus are provided to perform network slice admission control within a service area of an operator network and across service areas of the operator network. A central Network Slice Admission Control Function (NSACF) supporting multiple service areas of at least one operator network receives an admission request from a network function (e.g., AMF, SMF or SMF+PGW-C) belonging to a service area of an operator network. The admission request includes information identifying the service area and may include an identifier of the network operator. The central NSACF performs network slice admission control based on whether the UE is newly admitted to the network slice in the service area or whether the UE has already been admitted in a different service area.

### RELATED APPLICATIONS

This application claims the benefit of provisional patent application Ser. No. 63/319,440, filed on Mar. 14, 2022, the disclosure of which is hereby incorporated herein by reference in its entirety.

### TECHNICAL FIELD

The present disclosure relates to Network Slice admission control in a telecommunication system.

### BACKGROUND

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

Third Generation Partnership Project (3GPP) Technical Specification (TS) 23.501 V17.2.0 and TS 23.502 V17.2.1 define, among other things, aspects related to Network Slice Admission Control (NSAC). In particular, the NSAC procedures track the number of User Equipments (UEs) or Protocol Data Unit (PDU) sessions on each network slice and deny access to further UEs once a maximum number of UEs or a maximum number of PDU sessions has been reached for that network slice.

3GPP Release 17 proposed that the Public Land Mobile Network (PLMN) can but need not be divided into many service areas. When a PLMN is divided into more than one service area, each service area is uniquely and unambiguously identified with no overlap between the neighboring service areas (FIG. 1). AMFs in a service area interact only with NSACF in their local service area for the purpose of admission control. Any S-NSSAI in a service area is handled by one NSCAF.

### SUMMARY

There currently exist certain challenge(s). More specifically, UEs that move between service areas of a Public Land Mobile Network (PLMN) or standalone non-public network (SNPN) must be admitted regardless of the status of the count in the new service area. This ensures service continuity between service areas of the same PLMN. For example, the case of inter-AMF mobility between 2 AMFs in 2 different service areas.

In addition, interworking for slices between the Evolved Packet System, 4G (EPS) and 5G System (5GS) have the same issue, when the interworking is within the same PLMN. If EPS count is active, hence a UE that moves from EPS to 5GS (or vice versa) must be allowed to continue since he has already been admitted. This applies to roaming and non-roaming UEs.

The handling of network slice admission control in a PLMN supporting more than one service areas were not addressed in Release 17 in a standardized way. It was left for implementations to handle these cases.

Certain aspects of the present disclosure and their embodiments may provide solutions to the challenges described above. The embodiments described herein are explained for the 5G system (5GS) and 5GS interworking with the Evolve Packet System (EPS), however, it is apparent that the solution can be applied to any system using network slicing, including future 6G systems.

The solution is composed of various embodiments described herein where it is proposed that a single central NSACF network function performs the PLMN global counting and/or SNPN global counting to ensure a consistent counting across all the service areas supported by the PLMN, e.g., such that during mobility or handover between the different Service Areas of the PLMN, no additional admission needs to be performed i.e., central NSACF does not need to increment the counter).

The Service Area can belong to a Public Land Mobile Network (PLMN) or a standalone non-public network (SNPN). In the reminder of the solution description, the PLMN is used to describe the embodiments, however, it will be understood that the same embodiments can apply to an SNPN and even in a mixt PLMN-SNPN scenario. For example, where a user moves from a service area of a PLMN to a service area of an SNPN (and vice versa) and session continuity is required, the scenarios described herein apply as well. In the mixt scenario, the central NSACF should be able to handle PLMN and SNPN global counting.

Certain embodiments may provide one or more of the following technical advantage(s). Embodiments of the present disclosure provide solution(s) to support Centralized Counting for Multiple Service Areas and 5GS-EPS Interworking within a PLMN when the PLMN supports multiple Service Areas.

In accordance with some embodiments, a method, which is implemented in a system comprising one or more network functions e.g., AMF, SMF, SMF+PGW-C, UE and a central NSACF is provided. The method comprises at a network node implementing a network function (AMF, SMF, SMF+PGW-C) belonging to a Service Area of an operator network that receives from a User Equipment UE a request comprising information that indicates a network slice that is subject to Network Slice Admission Control, NSAC, then sends an admission request to a central Network Slice Admission Control Function, NSACF, supporting multiple Service Areas of the operator network to request network slice admission control of the UE to the network slice in the service area. The admission request comprises information indicating the Service Area of the network node implementing the network function.

The method further comprises at the central NSACF receiving from the network node the admission request for the UE (112) in the network slice, the admission request comprising the information indicating the Service Area of the network function and determining whether the UE has previously been admitted in a different Service Area of the operator network. Based on the result of the determining, the NSACF performing one of two actions.

Action 1: in response to determining that the UE has previously been admitted in a different Service Area of the operator network, the central NSACF storing by updating the information received in the admission request without increasing a global count associated with either a number of registered UEs in the network slice or a total number of Packet Data Unit (PDU) Sessions in the network slice; or
Action 2: in response to determining that the UE has not previously been admitted in a different Service Area of the operator network, enforcing the global count by checking whether the global count has not been reached by the admission request.
In one embodiment, enforcing the global count further comprises upon determining by the central NSACF the global count has reached a maximum for the network slice, the central NSACF transmitting a message to the network function that the UE should not be admitted to the network slice or upon determining the global count has reached its maximum, incrementing the global count and allow the admission.

In accordance with another example, the central NSACF determining whether the UE has previously been admitted in a different Service Area of the operator network corresponds to whether the UE has moved from the different service area to the service area. For example, the different service area corresponds to a service area of a first core network and the service area corresponds to a service area of a second core network. For example, the first core network is one of 4G Core network or 5G Core network and the second core network corresponds to the other one of the 5G core network or 4G core network.

In accordance with an embodiment, the admission request further comprises information identifying the operator network which may be a public land mobile network (PLMN) or a Stand-alone Non-Public Network (SNPN) and the information identifying the operator network is either a PLMN identifier or an SNPN identifier.

In accordance with another embodiment a method of performing network slice admission control at a node implementing a network function (e.g., AMF, SMF or SMF+PGW-C) belonging to one Service Area of an operator network is provided. The method comprises the step of receiving from a User Equipment UE a request comprising information that indicates a network slice that is subject to Network Slice Admission Control, NSAC. The method further comprises the step of sending by the network function an admission request to a central Network Slice Admission Control Function, NSACF, (400; 600) supporting multiple Service Areas of the operator network, to request network slice admission control of the UE to the network slice in the service area of the network function wherein the admission request comprises information indicating the Service Area of the network function, for example an identifier of the service area.

In one example, the admission request further comprises information identifying the operator network which may be a public land mobile network (PLMN) or a Stand-alone Non-Public Network (SNPN) and wherein the information identifying the operator is either a PLMN identifier or an SNPN identifier.

In accordance with another embodiment, a method performed by a central Network slice admission Control function NSACF in an operator network, the NSACF supporting multiple service areas of the operator network is provided. The method comprises, the central NSACF receiving from a network function (AMF, SMF or SMF+PGW-C) an admission request for a User Equipment (UE), where the admission request comprises information indicating a Service Area of the network function, and wherein the admission request is to request admission of the UE to the network slice in the service area; and the central NSACF determining whether the UE has previously been admitted in a different Service Area of the operator network and based on the result of the determining, performing one of two actions (Action 1 and Action 2). In one example, determining whether the UE has previously been admitted in a different Service Area of the operator network corresponds to whether the UE has moved from the different service area to the service area where the different service area corresponds to a service area of a first core network and the service area corresponds to a service area of a second core network and where the first core network is one of 4G Core network or 5G Core network and the second core network corresponds to the other one of the 5G core network or 4G core network.

In one embodiment: Action 1: (one action of the two actions) is in response to determining that the UE has previously been admitted in a different Service Area of the operator network, the central NSACF storing by updating the information received in the admission request without increasing a global count associated with either a number of registered UEs in the network slice or a total number of Packet Data Unit (PDU) Sessions in the network slice.

Action 2 (the other action of the two actions): in response to determining that the UE has not previously been admitted in a different Service Area of the operator network, enforcing the global count by checking whether the global count has not been reached by the admission request.

In one embodiment, the central NSACF enforcing the global count further consists of upon determining by the central NSACF that the global count has reached a maximum for the network slice, transmitting a message to the network function that the UE should not be admitted to the network slice or denied access and upon determining the global count has reached its maximum, the central NSACF increments the global count and allow the admission.

In one example the admission request received by the central NSACF further comprises information identifying the operator network which may be a public land mobile network (PLMN) or a Stand-alone Non-Public Network (SNPN) and wherein the information identifying the operator is either a PLMN identifier or an SNPN identifier.

In other embodiment, a system comprising at least one node implementing a network function such as AMF, SMF, SMF+PGW-C and a central NSACF is adapted to perform any of the embodiments described herein.

In another embodiment, a network node or server comprising one or more processor and memory comprising instructions which when executed perform any of the methods described herein.

In another embodiment, the instructions describing any of the embodiments described herein are stored in a computer readable medium, which when executed by one or more processors would execute any of the embodiments and examples described herein.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates a network slice concept across multiple service areas.

FIG. 2 illustrates one example of a cellular communications system in which embodiments of the present disclosure can be implemented;

FIG. 3 illustrate example embodiments in which the cellular communication system of FIG. 1 is a Fifth Generation (5G) System (5GS);

FIG. 4 illustrate the service-based interface (SBI) architecture view of the (5G) System (5GS) of FIG. 3;

FIG. 5 illustrates a procedure in accordance with one embodiment of the present disclosure;

FIG. 6 illustrates another procedure in accordance another embodiment of the present disclosure;

FIG. 7A illustrates a method in a node implementing a central NSACF in accordance with some embodiments of the present disclosure;

FIG. 7B illustrates a method in a node implementing a Network function (e.g., AMF, SMF) in accordance with an embodiment of the present disclosure; and

FIGS. 8, 9, and 10 are schematic block diagrams of example embodiments of a network node.

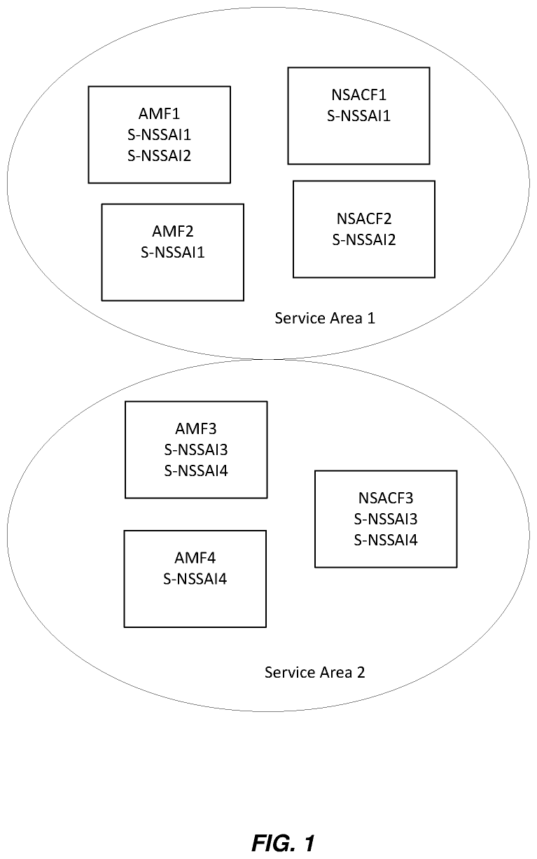

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Radio Node: As used herein, a “radio node” is either a radio access node or a wireless communication device.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station (e.g., a network node that implements a gNB Central Unit (gNB-CU) or a network node that implements a gNB Distributed Unit (gNB-DU)) or a network node that implements part of the functionality of some other type of radio access node.

Core Network Node: As used herein, a “core network node” is any type of node in a core network or any node/server/distributed servers/dedicated platform that implements one or more core network function also referred to as Network Function. Some examples of Network Function include, e.g., a Mobility Management Entity (MME), a Packet Data Network Gateway (P-GW), a Service Capability Exposure Function (SCEF), a Home Subscriber Server (HSS), or the like. Some other examples of a Network Function include a node implementing an Access and Mobility Management Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), SMF+PGW controller, and Network slice admission control function (NSACF) or the like. In general, a network function can be implemented either as a network element on a dedicated hardware, as a software instance running on a dedicated hardware, or as a virtualised function instantiated on an appropriate platform, e.g. on a cloud infrastructure.

Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

Wireless Communication Device: One type of communication device is a wireless communication device, which may be any type of wireless device that has access to (i.e., is served by) a wireless network (e.g., a cellular network). Some examples of a wireless communication device include, but are not limited to: a User Equipment device (UE) in a 3GPP network, a Machine Type Communication (MTC) device, and an Internet of Things (IoT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Network Node: As used herein, a “network node” is any node that is either part of the RAN or the core network of a cellular communications network/system.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

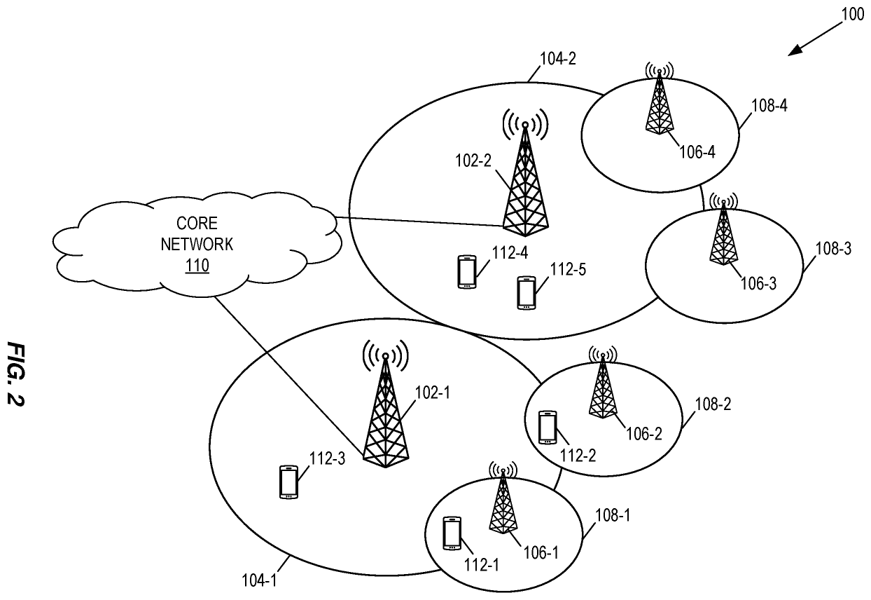

FIG. 2 illustrates one example of a cellular communications system 100 in which embodiments of the present disclosure may be implemented. In the embodiments described herein, the cellular communications system 100 is a 5G system (5GS) including a Next Generation RAN (NG-RAN) and a 5G Core (5GC); however, the present disclosure is not limited thereto. In this example, the RAN includes base stations 102-1 and 102-2, which in the 5GS include NR base stations (gNBs) and optionally next generation eNBs (ng-eNBs) (e.g., LTE RAN nodes connected to the 5GC), controlling corresponding (macro) cells 104-1 and 104-2. The base stations 102-1 and 102-2 are generally referred to herein collectively as base stations 102 and individually as base station 102. Likewise, the (macro) cells 104-1 and 104-2 are generally referred to herein collectively as (macro) cells 104 and individually as (macro) cell 104. The RAN may also include a number of low power nodes 106-1 through 106-4 controlling corresponding small cells 108-1 through 108-4. The low power nodes 106-1 through 106-4 can be small base stations (such as pico or femto base stations) or RRHs, or the like. Notably, while not illustrated, one or more of the small cells 108-1 through 108-4 may alternatively be provided by the base stations 102. The low power nodes 106-1 through 106-4 are generally referred to herein collectively as low power nodes 106 and individually as low power node 106. Likewise, the small cells 108-1 through 108-4 are generally referred to herein collectively as small cells 108 and individually as small cell 108. The cellular communications system 100 also includes a core network 110, which in the 5G System (5GS) is referred to as the 5GC. The base stations 102 (and optionally the low power nodes 106) are connected to the core network 110.

The base stations 102 and the low power nodes 106 provide service to wireless communication devices 112-1 through 112-5 in the corresponding cells 104 and 108. The wireless communication devices 112-1 through 112-5 are generally referred to herein collectively as wireless communication devices 112 and individually as wireless communication device 112. In the following description, the wireless communication devices 112 are oftentimes UEs and as such sometimes referred to herein as UEs 112, but the present disclosure is not limited thereto.

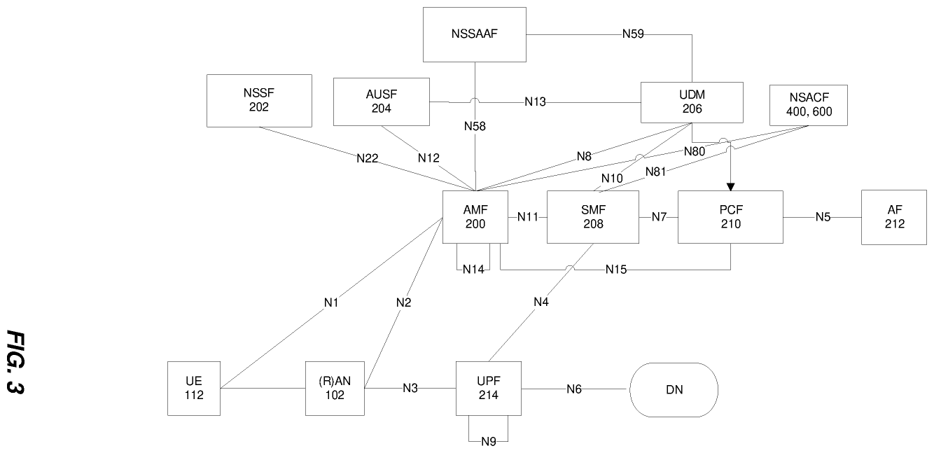

FIG. 3 illustrates a wireless communication system represented as a 5G network architecture composed of core Network Functions (NFs), where interaction between any two NFs is represented by a point-to-point reference point/interface. FIG. 2 can be viewed as one particular implementation of the system 100 of FIG. 2.

Seen from the access side the 5G network architecture shown in FIG. 3 comprises a plurality of UEs 112 connected to either a RAN 102 or an Access Network (AN) as well as an AMF 200. Typically, the R(AN) 102 comprises base stations, e.g. such as eNBs or gNBs or similar. Seen from the core network side, the 5GC NFs shown in FIG. 3 include a NSSF 202, an AUSF 204, a UDM 206, the AMF 200, a SMF 208, a PCF 210, an NSACF (400) and an Application Function (AF) 212.

Reference point representations of the 5G network architecture are used to develop detailed call flows in the normative standardization. The N1 reference point is defined to carry signaling between the UE 112 and AMF 200. The reference points for connecting between the AN 102 and AMF 200 and between the AN 102 and UPF 214 are defined as N2 and N3, respectively. There is a reference point, N11, between the AMF 200 and SMF 208, which implies that the SMF 208 is at least partly controlled by the AMF 200. N4 is used by the SMF 208 and UPF 214 so that the UPF 214 can be set using the control signal generated by the SMF 208, and the UPF 214 can report its state to the SMF 208. N9 is the reference point for the connection between different UPFs 214, and N14 is the reference point connecting between different AMFs 200, respectively. N15 and N7 are defined since the PCF 210 applies policy to the AMF 200 and SMF 208, respectively. N12 is required for the AMF 200 to perform authentication of the UE 112. N8 and N10 are defined because the subscription data of the UE 112 is required for the AMF 200 and SMF 208. The Network Slice Admission Control (NSACF 400, 600) uses reference points N81 and N80 towards the SMF 208 and AMF 200 respectively for slice admission control at registration and PDU session establishment.

The 5GC network aims at separating UP and CP. The UP carries user traffic while the CP carries signaling in the network. In FIG. 3, the UPF 214 is in the UP and all other NFs, i.e., the AMF 200, SMF 208, PCF 210, AF 212, NSSF 202, AUSF 204, and UDM 206, are in the CP. Separating the UP and CP guarantees each plane resource to be scaled independently. It also allows UPFs to be deployed separately from CP functions in a distributed fashion. In this architecture, UPFs may be deployed very close to UEs to shorten the Round Trip Time (RTT) between UEs and data network for some applications requiring low latency.

The core 5G network architecture is composed of modularized functions. For example, the AMF 200 and SMF 208 are independent functions in the CP. Separated AMF 200 and SMF 208 allow independent evolution and scaling. Other CP functions like the PCF 210 and AUSF 204 can be separated as shown in FIG. 2. Modularized function design enables the 5GC network to support various services flexibly.

Each NF interacts with another NF directly. It is possible to use intermediate functions to route messages from one NF to another NF. In the CP, a set of interactions between two NFs is defined as service so that its reuse is possible. This service enables support for modularity. The UP supports interactions such as forwarding operations between different UPFs.

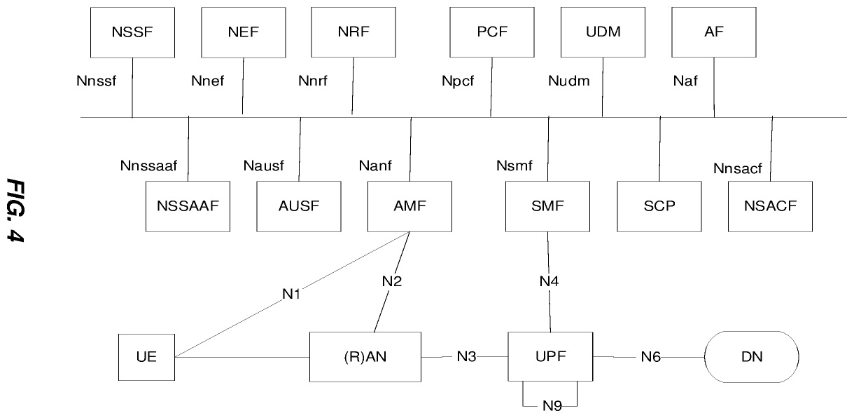

FIG. 4 illustrates a 5G network architecture using service-based interfaces between the NFs in the CP, instead of the point-to-point reference points/interfaces used in the 5G network architecture of FIG. 3. However, the NFs described above with reference to FIG. 3 correspond to the NFs shown in FIG. 4. The service(s) etc. that a NF provides to other authorized NFs can be exposed to the authorized NFs through the service-based interface. In FIG. 4 the service based interfaces are indicated by the letter “N” followed by the name of the NF, e.g. Namf for the service based interface of the AMF 200 and Nsmf for the service based interface of the SMF 208, etc. The NEF 300 and the NRF 302 in FIG. 4 are not shown in FIG. 3 discussed above. However, it should be clarified that all NFs depicted in FIG. 3 can interact with the NEF 300 and the NRF 302 of FIG. 4 as necessary, though not explicitly indicated in FIG. 3.

Some properties of the NFs shown in FIGS. 3 and 4 may be described in the following manner. The AMF 200 provides UE-based authentication, authorization, mobility management, etc. A UE 112 even using multiple access technologies is basically connected to a single AMF 200 because the AMF 200 is independent of the access technologies. The SMF 208 is responsible for session management and allocates Internet Protocol (IP) addresses to UEs. It also selects and controls the UPF 214 for data transfer. If a UE 112 has multiple sessions, different SMFs 208 may be allocated to each session to manage them individually and possibly provide different functionalities per session. The AF 212 provides information on the packet flow to the PCF 210 responsible for policy control in order to support QoS. Based on the information, the PCF 210 determines policies about mobility and session management to make the AMF 200 and SMF 208 operate properly. The AUSF 204 supports authentication function for UEs or similar and thus stores data for authentication of UEs or similar while the UDM 206 stores subscription data of the UE 112. The Data Network (DN), not part of the 5GC network, provides Internet access or operator services and similar. The Network Slice Admission Control Function (NSACF 400) monitors and controls the number of registered UEs per network slice and/or the number of PDU Sessions per network slice for the network slices that are subject to Network Slice Admission Control (NSAC).

Certain aspects of the present disclosure and their embodiments may provide solutions to the aforementioned or other challenges. Embodiments of the solutions described herein propose a central NSACF deployed over the multiple service areas of a PLMN. The central NSACF performs the PLMN global counting to ensure a consistent counting, e.g., such that during handover or mobility between different Service Areas of the PLMN, no additional admission needs to be performed. The admission request includes all necessary information to enable the central NSACF to collect all pertinent information per Service Area. Interaction between the NF performing the admission, be it the SMF or the AMF, occurs with the designated central NSACF (also referred sometimes as central NF) for that purpose.

The central NSACF is responsible for PLMN global count for the network slice identified by an S-NSSAI, i.e., the central NSACF knows keep track of the count of number of registered UE to a network slice and/or number of PDU sessions in the network slice in the whole PLMN. In addition, the central NSACF may keep track of the count on a per service area of the PLMN. Hence two counts are maintained and tracked, at the PLMN level and at the service area of the PLMN level (note as indicated earlier, the same applies when substituting the PLMN with SNPN).

The central NSACF enforces the global count at the PLMN level, i.e., keeps track of the usage of the network slice across all the service areas of the PLMN, but it may maintain individual counts per service area for the network slice. A network operator, be it a PLMN or SNPN may deploy in addition to a central NSACF, a local NSACF which interacts locally with the AMF/SMF to keep count of number of registered UE to a network slice and/or number of PDU sessions in the network slice within the service area configured for the AMF and SMF as well. If the central NSACF provisions the local NSACF properly based on its information, then the count per service area in the central NSACF and in the local NSACF should be aligned.

If the central node does not provision the locals NSACFs properly then misalignment can occur, and local NSACF can go over quota for the service area, however the central NSACF should have the accurate count.

The central NSACF is discovered by the AMF and/or SMF via NRF or can be pre-configured in the AMF and/or SMF. Each AMF and SMF belongs to a single Service Area configured in the AMF and SMF. Therefore, when the AMF uses NRF to discover the NSACF to use, it compares its configured Service Area vs the ones provided in the NSACF profile as part of the discovery. An AMF or an SMF that requests admission control (directly or indirectly) from the central NSACF will include information indicating the identity of the Service Area to which the request pertains and may include an identification of the PLMN supporting the Service Area. One central NSACF can be deployed per PLMN supporting multiple Service Areas, alternatively, the central NSACF can support multiple PLMNs each supporting multiple Service Areas, such as for example in a roaming scenario where the central NSACF is for example in the home PLMN and the users are roaming in other PLMNs and home routing is used, or in the case of 5G System to Evolve packet system (EPS) interworking when the UE moves between 5GS and EPS using interworking providing session continuity, the 5GS and the EPS may belong to two different PLMNs supported by the central NSACF. When the central NSACF supports multiple PLMNs, the request for admission control should identify the PLMN to which the Service Area corresponds to, for Example, the request may likely include an explicit identifier of the PLMN in addition to the identity of the Service Area.

Note that in the scenarios of 5GS-EPS interworking, the 5GS and EPS may belong to one PLMN or to different PLMNs. One central NSACF is used either way and secure session continuity as the UE moves between 5GS and EPS hanging service areas.

Note that if the identity of the Service Area includes the PLMN identifier, it may not be necessary to include a separate PLMN identifier attribute in the request for Admission control.

however, in case of roaming UE, the PLMN ID is transmitted to the central NSACF enabling the central NSACF to identify the roaming UEs.

Two options are proposed to enable the AMF/SMF in a Service Area to perform some local tasks; e.g. keeping local statistics in conjunction with centralized counting with a single central NSACF NF:

### Option 1: Transparent Proxying to Central NSACF Via an Intermediate NF

Based on policy, an NF such as the SMF or the AMF performing the admission with the central NSACF may additionally and optionally interact with a local NF (e.g., local NSACF) associated with one of the Service Area of the PLMN accessed by the UE where the UE is located, for any additional capabilities not supported by the central NSACF. Such additional capabilities are not specified. but can be e.g. to keep local statistics. For clarity, a local NSACF is deployed for one Service Area only and the central NSACF is deployed for multiple service areas of a PLMN.
The interaction with such a local NF (e.g., local NSACF) is such, that the local NF (e.g., local NSACF) in the Service Area where the UE is located proxies the original request, as is, to the central NSACF, after performing the tasks it desires upon receipt of the admission Request intended for the central NSACF NF. Hence, in this option1, the interaction with the central NSACF server is proxied via an intermediate NF (i.e., local NF/local NSACF) to the central NF, as long as it is transparent to the central NSACF. Transparent means that the central NSACF cannot distinguish whether the Request is direct from the AMF/SMF or proxied via the intermediate NF (i.e., via the local NF or local NSACF).

### Option 2: Dual Interaction with Local NF, and Central NSACF NF

Based on policy, an NF, such as the SMF or the AMF performing the admission with the central NSACF may additionally and optionally interact with a local NF (e.g., local NSACF) associated with one of the Service Area of the PLMN accessed by the UE where the UE is located, for any additional capabilities not supported by the central NSACF. Such additional capabilities are not detailed herein, albeit examples could include keeping local statistics
Hence the AMF/SMFs performs dual interactions in parallel; once towards the central NSACF, and an additional one towards a local NF (e.g., local NSACF) in the Service Area of the PLMN where the UE is located.
In support of roaming, and to enable such a central NSACF to handle roaming UEs, as well as home bound UEs, the admission query to the central NSACF includes the PLMN-ID where the UE is roaming.
To support EPS counting while interworking with 5GS when activated and where home routing is the only option for attachment to EPS, a central NSCAF could be dedicated for 5GS-EPS interworking shared count, albeit not necessary. In this case, such a dedicated central NSACF is discovered, i.e., a central NSACF for EPS-5GS interworking. The PLMN can also reuse a single central NSACF for all admissions in the Service Areas for 5GS only slices or 5GS-EPS interworking slices. Furthermore, for the scenario of 5GS-EPS interworking, the 5GS and EPS may belong to one PLMN or different PLMNs, in which case the central NSACF can handle counting for multiple PLMNs, where in this scenario, i.e., 5GS-EPS interworking, the central NSACF will be able to secure session continuity for UEs moving between two different Service Areas of the same PLMN or of different PLMNs. The central NSACF would secure session continuity by not incrementing the count and allowing the access even if the maximum number of UEs for the slice is reached as the UE has previously been admitted in a previous Service Area and is simply moving to another Service Area.

Similar to the 5GS case, i.e., the case is in the 5GS and moves into different service areas in 5GS, and based on policy, a NF (e.g., AMF, SMF) performing admission with the central NSACF responsible for the shared 5GS-EPS count may additionally and optionally interact with a local NF (e.g., local NSACF) associated with the Service Area where the UE is located, for any additional capabilities not supported by the central NSACF. Such additional capabilities are for example keeping local statistics within one Service Area. Hence, in this case as well, both options 1 and 2 above for 5GS only slices are supported for the 5GS-EPS interworking case.

### UE Registration Admission, 5GS Only Slices

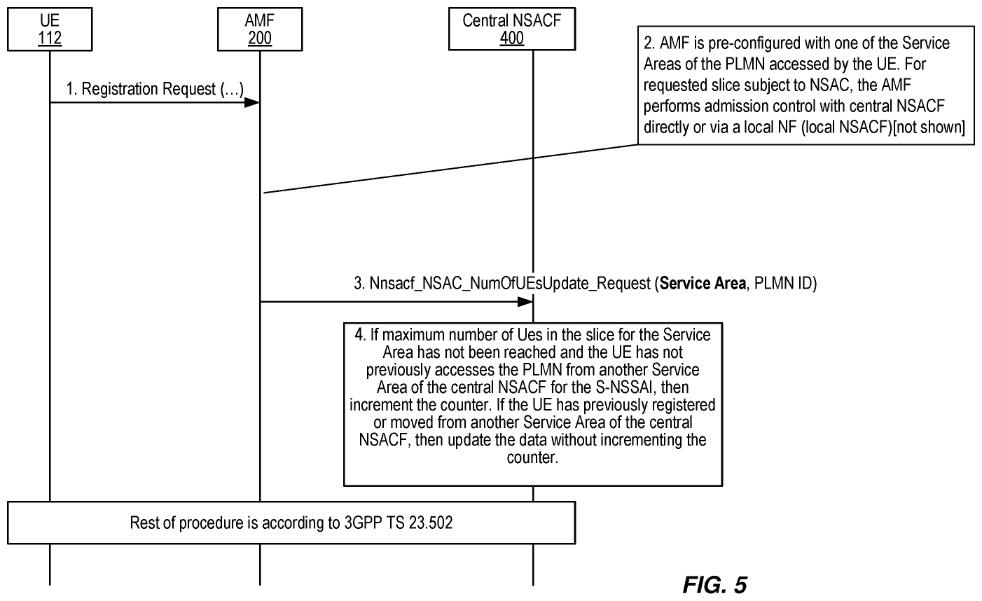

FIG. 5 illustrates a network slice admission procedure in accordance with an embodiment of the present disclosure.

In this procedure, there is a single central NSACF performing the count for the entire PLMN. The AMF discovers the central NSACF performing the PLMN global counting. The NF profile for the NSACF is updated to indicate that the NSACF is the central NSACF for the S-NSSAI handling the PLMN global count for 5GS slices, and the central NSACF information can be encoded as part of the NSACF service capabilities as a specific capability or as part of the NSACF Serving Area information.

Step 1: In step 1, the UE 112 issues a Registration request, e.g., as per existing procedures in 3GPP TS 23.502. The registration request is for a particular network slice. In this example, the particular network slice is indicated by a particular S-NSSAI, and the S-SNSSAI is subject to admission control for the maximum number of registered UEs.

Step 2: Since the AMF is configured to belong to one Service Area of the PLMN to which the UE is attempting to register, the AMF selects a central NSACF that supports the service Area in order to perform admission control.

Step 3: The AMF performs admission as in section 4.2.11.2 of TS 23.502, with the following changes:
The AMF transmits to the central NSACF an Admission request to update the number of UEs in the Service Area for the network slice (Nnsacf_NSAC_NumOfUEsUpdate_Request) and includes information indicating the Service Area and the PLMN ID where the UE is currently located.
The AMF performs admission control with the central NSACF according to option 1 or option 2 above:
   In support of option 1 above, the AMF, based on policy, communicates directly with central NSACF (as shown in FIG. 5) or via an intermediate NF (e.g., local NSACF) that proxies the original request unaltered to the central NSACF. The actions performed in the intermediate NF are out of scope.
   In support of option 2 above, the AMF, based on policy, sends the admission request to the central NSACF and sends the admission request as well to a local NF (local NSACF) in the Service Area where the UE is located. The local NF performs local tasks such as keeping local statistics.

Step 4: The central NSACF does not change the number of registered UE for a UE that is moving between multiple Service Areas supported by the central NSACF given that the UE has already been admitted and successfully registered in an old Service Area. In this case, the central NSACF NF performing the PLMN global counting only updates the UE stored information. Alternatively, the central NSACF increments the number of registered UEs for the network slice in the Service area if the UE has not previously registered or moved from another Service Area supported by the central NSACF.

The AMF, in case the policy is to communicate additionally with local NSACFs (option 2), updates the applicable local NSACF with the change i.e. UE leaving one Service Area and entering the new Service Area.

### UE Registration Admission, 5GS-EPS Interworking With EPS Counting Active

To support network slice admission control in 5GS-EPS Interworking, a shared count for maximum number of Registered UEs for interworking between 5GS and EPS is used. The count can be performed by a central NSACF dedicated for 5GS-EPS interworking, or a common central NSACF that handles 5GS slices and slices for EPS-5GS interworking can be used.

If a dedicated 5GS-EPS central NSACF NF is used, the AMF/SMF+PGW-C discovers the central NSACF handling the shared 5GS-EPS count for the number of Registered UEs. The NF profile for the central NSACF is updated to indicate that the NSACF is the central NSACF for the for shared 5GS-EPS count for number of Registered UEs. The central NSACF information can be encoded as part of the NSACF service capabilities as a specific capability or as part of the shared 5GS-EPS count.

Similar to FIG. 5, the AMF/SMF+PGW-C performs admission as in clause 4.2.11.2 of TS 23.502 with the following changes:

The AMF/SMF+PGW-C includes information indicating the Service Area and the PLMN ID where the UE is currently located in its admission request to the central NSACF responsible for shared 5GS-EPS count for number of Registered UEs.

The AMF/SMF+PGW-C performs either option 1 or option 2 below:
In support of option 1 above, the AMF/SMF+PGW-C, based on policy, communicates directly with the central NSACF or via an intermediate NF that proxies the original request unaltered to the central NSACF. The actions performed in the intermediate NF are out of scope.
In support of option 2 above, the AMF/SMF+PGW-C, based on policy, sends the admission request to the central NSACF, and sends the admission request as well to a local NF (e.g., local NSACF) in the Service Area where the UE is located. The local NF (e.g., local NSACF) performs local tasks.

The central NSACF responsible for the shared 5GS-EPS count or number of Registered UEs does not change the number of registered UE for a UE that is moving between multiple Service Areas of the PLMN (in this case given that the UE is moving between EPS and 5GS belonging to different PLMNs, the Service areas will have to be different) given that the UE has already been admitted and registered in a previous Service Area of the PLMN supported by the central NSACF as it has been counted for. In that case, the central NSACF handling the shared 5GS-EPS count simply updates the UE stored information and does not increment the count.

The AMF/SMF+PGW-C, in case the policy is to communicate additionally with local NSACFs (option 2), updates the applicable local NSACF with the change i.e. UE leaving one access (4G or 5G) to another access (5G or 4G).

### UE PDU Session Admission, 5GS Only Slices

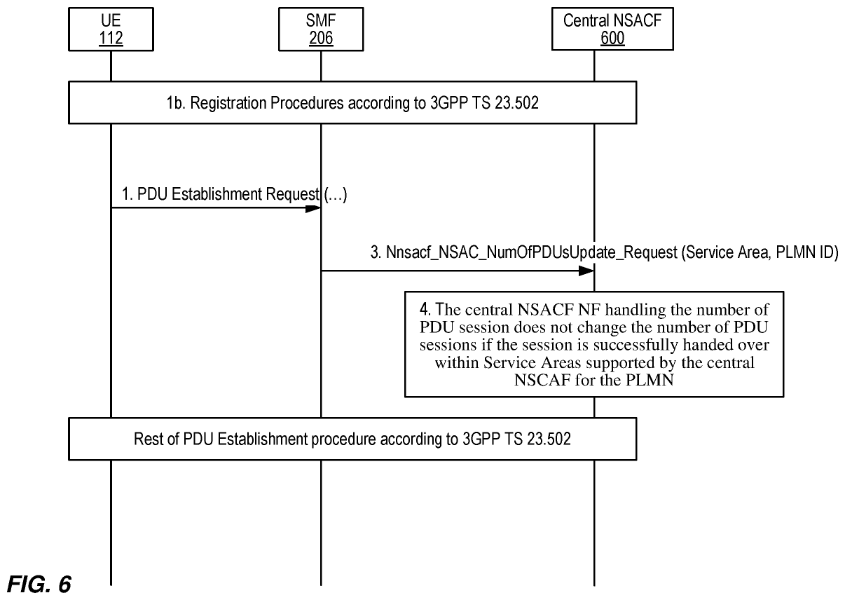

FIG. 6 illustrates an embodiment of the present disclosure when the UE establishes a PDU session to a network slice.

In this procedure, there is a single central NSACF performing the count for the entire PLMN. The SMF discovers the central NSACF performing the PLMN global counting for number of PDU sessions for network slices subject to NSAC. The NF profile for the central NSACF is updated to indicate that the NSACF is the central NSACF for the S-NSSAI handling the PLMN global count for the number of PDU sessions and the central NSACF information can be encoded as part of the NSACF service capabilities as a specific capability or as part of the NSACF Serving Area information.

The SMF performs admission as in section 4.2.11.4 of TS 23.502 with the following changes:

Step 1: In step 1, the UE 112 issues a PDU Session Establishment request, e.g., as per existing procedures in 3GPP TS 23.502. The PDU Session Establishment request is for a particular network slice. In this example, the particular network slice is indicated by a particular S-NSSAI, and the S-NSSAI is subject to admission control for the maximum number of PDU sessions.

Step 2: Since the SMF is configured to belong to one Service Area of the PLMN to which the UE is attempting to register, the SMF selects a central NSACF that supports the service Area in order to perform admission control. Alternatively, the SMF may receive the central NSACF identity/address from the AMF).

Step 3: The SMF transmits to the central NSACF an Admission request to update the number of UEs in the Service Area for the network slice and includes information indicating the Service Area and the PLMN ID where the UE is currently located.

The SMF performs admission with the central NSACF according to option 1 or option 2 above:
In support of option 1 above, the SMF, based on policy, communicates directly with central NSACF (as shown in FIG. 6) or via an intermediate NF (e.g., local NSACF) that proxies the original request unaltered to the central NSACF. The actions performed in the intermediate NF are out of scope.
In support of option 2 above, the SMF, based on policy, sends the admission request to the central NSACF and sends the admission request as well to a local NF (local NSACF) in the Service Area where the UE is located. The local NF (local NSACF) performs local tasks such as keeping local statistics.

Step 4: When a PDU session is handed over between two Service Areas, the central NSACF handling the number of PDU session does not change the number of PDU sessions if the session is successfully handed over. In case of a successful handover, the central NSACF performing the PLMN global counting simply updates the UE stored information. The SMF, in case the policy is to communicate additionally with local NSACFs (option 2), updates the applicable local NSACFs with the change i.e. UE leaving one Service Area and entering the new Service Area.

### UE PDU Session Admission, 5GS-EPS Interworking With EPS Counting Active

In this solution, there is a shared count for maximum number of PDU sessions between 5GS and EPS performed by a central NSACF dedicated for that purpose, or a common central NSACF used for 5GS slices and for EPS-5GS interworking can be used.

If a dedicated 5GS-EPS central NSACF NF is used, the SMF/SMF+PGW-C discovers the central NSACF NF handling the shared 5GS-EPS count for the number of PDU sessions for a slice subject to NSACF. The NF profile for the NSACF is updated to indicate that the NSACF is the central NSACF for the shared 5GS-EPS count for the number of PDU sessions. The central NSACF information can be encoded as part of the NSACF service capabilities as a specific capability or as part of the shared 5GS-EPS count.

Similar to FIG. 6, the SMF/SMF+PGW-C performs admission as in section 4.2.11.2 of TS 23.502 with the following changes:

The SMF/SMF+PGW-C transmits an admission request to the central NSACF responsible for shared 5GS-EPS count for maximum number of PDU sessions and includes the Service Area, the PLMN ID where the UE is currently located.

The SMF/SMF+PGW-C performs either option 1 or option 2 below:
In support of option 1 above, the SMF/SMF+PGW-C, based on policy, communicates directly with the central NSACF or via an intermediate NF (e.g., local NSACF) that proxies the original request unaltered to the central NSACF. The actions performed in the intermediate NF local and are outside the scope.
In support of option 2, the SMF/SMF+PGW-C, based on policy, sends the admission request to the central NSACF, and sends the admission request as well to a local NF (local NSACF) in the Service Area where the UE is located. The local NF performs tasks related to one service area only.

When a PDU session is handed over between 5GS and EPS, the central NSACF handling the number of PDU session does not change the number of PDU sessions if the session is successfully handed over between 5GS and EPS. In case of a successful handover, the central NSACF handling the shared 5GS-EPS count simply updates the UE stored information.

The SMF/SMF+PGW-C, in case the policy is to communicate additionally with local NSACFs (option 2), updates the applicable local NSACF with the change i.e. UE leaving one access (4G or 5G) to another access (the other 5G or 4G).

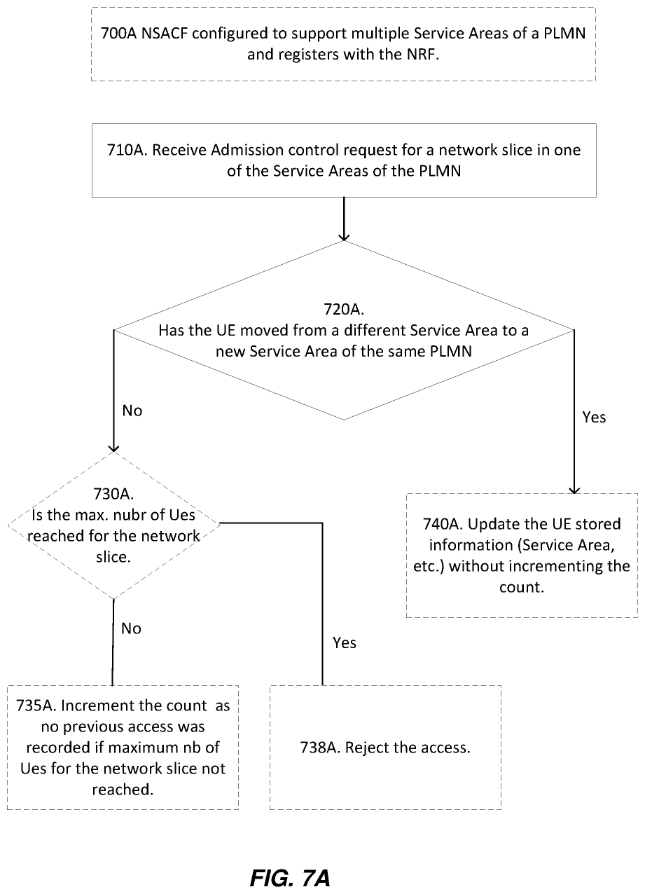

FIG. 7A illustrates a method performed by the central NSACF in accordance with some embodiments. The central NSACF is configured to support network slice admission control for a PLMN that supports multiple Service Areas. The central NSACF is responsible for PLMN global count for the network slice identified by an S-NSSAI, i.e., the central NSACF keeps track of the global count of number of registered UE to a network slice and/or number of PDU sessions in the network slice in the whole PLMN. In addition, the central NSACF may keep track of the count on a per service area of the PLMN. Hence two different counts are maintained and tracked, one global count at the PLMN level and secondary counts per service area of the PLMN (note as indicated earlier, the same applies when substituting the PLMN with SNPN).

The central NSACF enforces the global count at the PLMN level, i.e., determines when to increment the global count and reject admission requests by AMF/SMF if a maximum is reached. However, if the central NSACF maintains (secondary) counts per service area of the PLMN, and a maximum is reached for one service area, it may reject the admission request even if the global count is not reached. The NSACF at step 700A may be configured with the multiple service areas of an operator network (e.g., PLMN) and may register with the NRF that it is able to handle admission control to a network slice per service area. This step is performed independently of the network slice admission procedure that starts at step 710A. Further the central NSACF may in addition to supporting multiple service areas of one PLMN or operator network, it may also support multiple service areas for different PLMNs and/or SNPN, in which case the central NSACF should receive with the admission request from the network function (AMF, SMF, etc.) an identifier of the PLMN and/or of the SNPN.

Going back to FIG. 7A, Upon receiving at step 710A an Admission Request for the network slice comprising a Service Area and optionally a PLMN ID, from an AMF in response to a registration by a UE, or SMF or SMF+PGW-C in response to a session establishment by the UE (i.e., PDU session establishment in 5G or PDN connection establishment in 4G), the central NSACF at step 720A determines if it is a new access for the UE or whether the UE was previously admitted in another service area, i.e., the UE has performed a mobility procedure and changed service areas. The central NSACF would then continue either with step 730A or step 740A. For example, the central NSACF determines if the global counter associated to the network slice at the PLMN level was already incremented for the UE due to a previous Access by the UE in a different Service Area of the PLMN. If the UE has moved or handed over from a previous Service Area, the central NSACF, at step 740A updates the UE information (e.g., UE context, service area, network slice) without incrementing the global count. This will secure session continuity for the UE while in the PLMN.
Else, if the central NSACF does not have an existing UE context for the UE associated to a different service area, then the Admission Request for the network slice consists of a new Admission request for the UE, i.e., no previous access in any Service Area of the PLMN was logged for the UE, then at step 730A the NSACF determines if the maximum number of UEs using the network slice across the PLMN over all the Service Areas of the PLMN has not been reached, in which case, the central NSACF, at step 735A increments the global counter, the central NSACF updates the UE information as well and responds to the requester allowing the UE to be admitted to the network slice. However, if the max. number of UEs on the network slice is reached at step 730A, the central NSACF rejects the access at step 738A as per existing network slice admission control procedures specified in 3GPP TS 23.502.

FIG. 7B illustrates a method in a network function in a service area of an operator network which is either a PLMN or an SNPN. The method comprises the steps 710B of receiving from a User Equipment UE a request comprising information that indicates a network slice that is subject to Network Slice Admission Control, NSAC. The request may be a registration request or a PDU session establishment request or a request for a PDN connection if the UE is in the EPS. The network function may be an AMF, SMF or a combined SMF+PGW-C for interworking between EPS and 5GS.

The method further comprises step 720B of sending by the network function, an admission request to a central Network Slice Admission Control Function, NSACF, that supports multiple Service Areas of the operator network, to request network slice admission control of the UE to the network slice in the service area. The admission request comprises information indicating the Service Area of the network function (200, 206) and may further comprise information identifying the operator network which is either a public land mobile network (PLMN) or a Stand-alone Non-Public Network (SNPN). The information identifying the operator is either a PLMN identifier or an SNPN identifier. The admission request sent by the network function (AMF, SMF, SMF+PGW-C) may be sent as a result of UE mobility from one service area to another service area, where the service areas may be within two different systems, such as 5GS and EPS or within the same system (e.g., mobility within the 5GS). The network function receives at step 730B a response message to the admission request indicating whether the UE is admitted or rejected from the network slice in the service area.

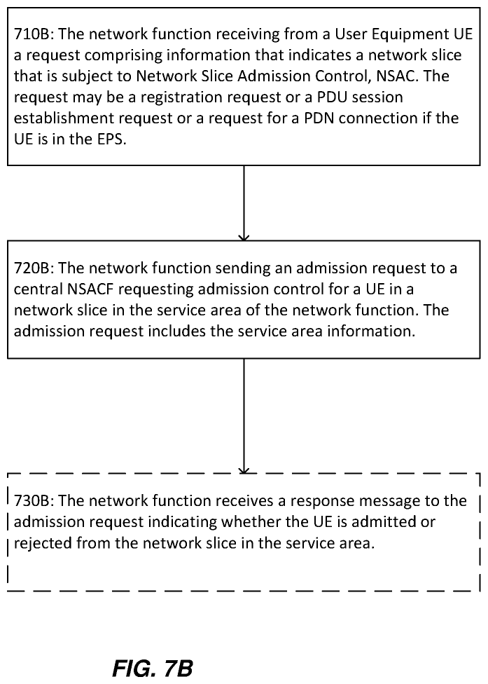

FIG. 8 is a schematic block diagram of a network node 800 according to some embodiments of the present disclosure. Optional features are represented by dashed boxes. The network node 800 may be, for example, a core network node that implements a NF (e.g., AMF 200, SMF 206, NSACF 400, NSACF 500, NSACF 600, NSACF 700, UDM/HSS 402, UDM/HSS 502, UDM/HSS 604, or UDR 702, or the like). As illustrated, the network node 800 includes a one or more processors 804 (e.g., Central Processing Units (CPUs), Application Specific Integrated Circuits (ASICs), Field Programmable Gate Arrays (FPGAs), and/or the like), memory 806, and a network interface 808. The one or more processors 804 are also referred to herein as processing circuitry. The one or more processors 804 operate to provide one or more functions of the network node 800 as described herein (e.g., one or more functions of the AMF 200, SMF 206, NSACF 400, NSACF 600, UDM/HSS 402, UDM/HSS 502, UDM/HSS 604, or UDR 702, or the like, as described herein). In some embodiments, the function(s) are implemented in software that is stored, e.g., in the memory 806 and executed by the one or more processors 804.

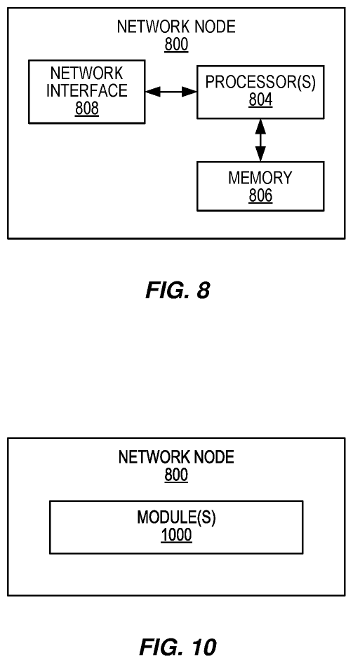

FIG. 9 is a schematic block diagram that illustrates a virtualized embodiment of the network node 800 according to some embodiments of the present disclosure. Again, optional features are represented by dashed boxes. As used herein, a “virtualized” network node is an implementation of the network node 800 in which at least a portion of the functionality of the network node 800 is implemented as a virtual component(s) (e.g., via a virtual machine(s) executing on a physical processing node(s) in a network(s)). As illustrated, in this example, the network node 800 includes one or more processing nodes 900 coupled to or included as part of a network(s) 902. Each processing node 900 includes one or more processors 904 (e.g., CPUs, ASICS, FPGAS, and/or the like), memory 906, and a network interface 908. In this example, functions 910 of the network node 800 described herein (e.g., one or more functions of the AMF 200, SMF 206, NSACF 400, NSACF 500, NSACF 600, NSACF 700, UDM/HSS 402, UDM/HSS 502, UDM/HSS 604, or UDR 702, or the like, as described herein)are implemented at the one or more processing nodes 900 or distributed across the two or more processing nodes 900 in any desired manner. In some particular embodiments, some or all of the functions 910 of the network node 800 described herein are implemented as virtual components executed by one or more virtual machines implemented in a virtual environment(s) hosted by the processing node(s) 900.

In some embodiments, a computer program including instructions which, when executed by at least one processor, causes the at least one processor to carry out the functionality of the network node 800 or a node (e.g., a processing node 900) implementing one or more of the functions 910 of the network node 800 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

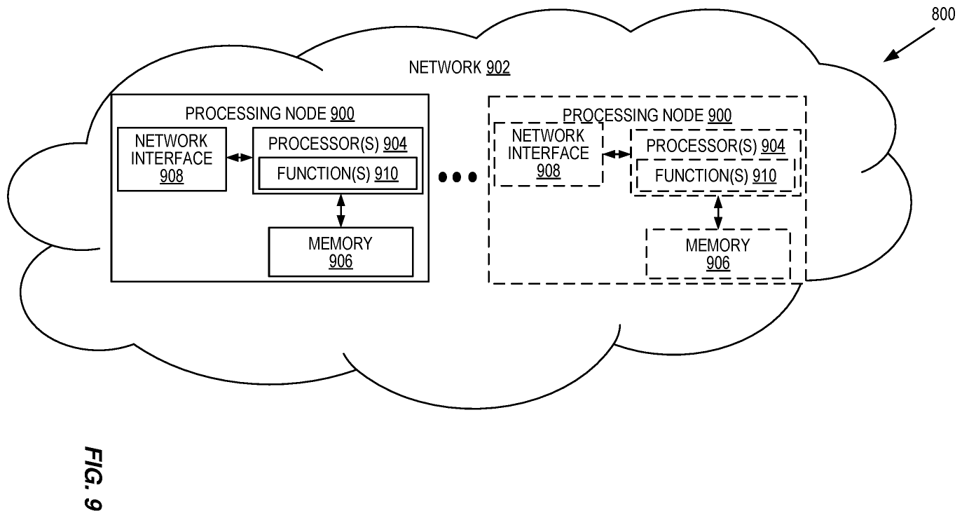

FIG. 10 is a schematic block diagram of the network node 800 according to some other embodiments of the present disclosure. The network node 800 includes one or more modules 1000, each of which is implemented in software. The module(s) 1000 provide the functionality of the network node 800 described herein. This discussion is equally applicable to the processing node 900 of FIG. 9 where the modules 1000 may be implemented at one of the processing nodes 900 or distributed across multiple processing nodes 900.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processors (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

Some example embodiments of the present disclosure are as follows:

A method comprising one or more of the following:
at a network node (200; 206) hosting a network function belonging to one Service Area of an operator network a):
   receiving from the UE (112) a request comprising information that indicates a particular network slice that is subject to Network Slice Admission Control, NSAC;
   sending an admission request to a central Network Slice Admission Control Function, NSACF, (400; 600) supporting multiple Service Areas of the operator network, wherein the admission request is a request to update a global count associated to a number of registered UEs or a number of PDU sessions in a network slice at the operator network level; and wherein the admission request comprises information indicating the Service Area to which the network node belongs and a network identifier identifying the operator network of the Service Area;
at the central NSACF (400; 600):
   receiving from the network node the admission request for the particular network slice, the admission request comprising the information indicating the Service Area and the network identifier; and
   in response to determining that the UE has previously been admitted via either a different Service Area of the operator network (e.g., UE moving from one Service Area to another Service Area), or a different Service Area of a different network (e.g., UE moving between 5GS to EPS where 5GS and EPS belong to two different networks), storing the UE information received in the admission request without increasing the global count associated with either the number of registered UEs in the network slice or the total number of PDU Sessions in the network slice; and
   in response to determining that the UE has not previously been admitted via a different Service Area of the operator network, enforce the global count by checking whether the global count has not maximum count associated with either a total number of registered UEs for the network slice or a total number of PDU Sessions for the network slice.

The method of embodiment 1 wherein the step of sending the admission request to a central Network Slice Admission Control Function, NSACF (400, 600), is performed directly or via an intermediary network function.

The method of embodiment 2 wherein the intermediary network function is a local NSACF.

The method of embodiment 1 further comprising the network node sending another admission request to a local Network Slice Admission Control Function, NSACF to update local counters within the service area.

The method of embodiment 1 further comprising the network node sending another admission request to a local Network Slice Admission Control Function, NSACF to update local counters within the service area.

The method of embodiment 1 further comprising the network node discovering the local Network Slice Admission Control Function, NSACF that supports the Service Area of the network node.

The method of embodiment 1 wherein the network node is an AMF, SMF or SMF+PGW-C.

The method of embodiment 1 wherein determining that the UE has previously been admitted via a different Service Area of the operator network corresponds to the UE moving or handover from the different Service Area to the Service Area.

The method of embodiment 1 wherein determining that the UE has previously been admitted via a different Service Area of the operator network corresponds to the UE moving or handing over from the different Service Area associated to a first core network to the Service Area associated to a second core network.

The method of embodiment 9 wherein the first core network is one of 4G Core network or 5G Core network and the second core network corresponds to the other one of the 5G core network or 4G core network.

The method of embodiment 1 wherein enforcing the global count further comprises:
upon determining the global count has reached a maximum for the network slice, transmit a message to the network node that the UE should not be admitted to the network slice; and
upon determining the global count has reached its maximum, increment the global count and allow the admission.

The method of embodiments 1 or 11, wherein the central NSACF further maintains and enforces a second count for the network slice per Service Area of the operator network.

The method of any one of the embodiments 1-12 wherein the network is either a public land mobile network (PLMN) or a Stand-alone Non-Public Network (SNPN) and wherein the network identifier is either a PLMN identifier or an SNPN identifier.

A system comprising a network node and a node hosting a central NSACF adapted to perform the method of any one of the embodiments 1 to 13.

Those skilled in the art will recognize improvements and modifications to the embodiments of the present disclosure. All such improvements and modifications are considered within the scope of the concepts disclosed herein.

1. (canceled)

2. (canceled)

3. (canceled)

4. (canceled)

5. (canceled)

6. (canceled)

7. (canceled)

8. (canceled)

9. (canceled)

10. A method of performing network slice admission control at a node implementing a network function belonging to one Service Area of an operator network, the method comprising:
receiving from a User Equipment UE a request comprising information that indicates a network slice that is subject to Network Slice Admission Control, NSAC;
sending an admission request to a central Network Slice Admission Control Function, NSACF, supporting multiple Service Areas of the operator network, to request network slice admission control of the UE to the network slice in the service area;
wherein the admission request comprises information indicating the Service Area of the network function.

11. The method of claim 10 wherein the network Function is an Access and Mobility management function (AMF), a Session Management Function (SMF) or SMF+Packet data Gateway Controller (SMF+PGW-C).

12. The method of claim 10, wherein the admission request further comprises information identifying the operator network.

13. The method of claim 12 wherein the operator network is either a public land mobile network (PLMN) or a Stand-alone Non-Public Network (SNPN) and wherein the information identifying the operator network is either a PLMN identifier or an SNPN identifier.

14. The method of claim 10 further comprising receiving a response message to the admission request indicating whether the UE is admitted or rejected from the network slice in the service area.

15. A method performed by a central Network slice admission Control function NSACF in an operator network, comprising:
receiving from a network function an admission request for a User Equipment (UE), comprising information indicating a Service Area of the network function, wherein the admission request is to request admission of the UE to the network slice in the service area; and
determining whether the UE has previously been admitted in a different Service Area of the operator network and based on the result of the determining, performing one of two actions.

16. The method of claim 15 wherein the step of performing one of two actions further comprises:
in response to determining that the UE has previously been admitted in a different Service Area of the operator network, storing by updating the information received in the admission request without increasing a global count associated with either a number of registered UEs in the network slice or a total number of Packet Data Unit (PDU) Sessions in the network slice; or
in response to determining that the UE has not previously been admitted in a different Service Area of the operator network, enforcing the global count by checking whether the global count has not been reached by the admission request.

17. The method of claim 16 wherein enforcing the global count further comprises:
upon determining the global count has reached a maximum for the network slice, transmitting a message to the network function (200, 206) indicating the UE should not be admitted to the network slice; and
upon determining the global count has reached its maximum, incrementing the global count and allow the admission.

18. The method of claim 15 wherein determining whether the UE has previously been admitted in a different Service Area of the operator network corresponds to whether the UE has moved from the different service area to the service area.

19. The method of claim 15 wherein the different service area corresponds to a service area of a first core network and the service area corresponds to a service area of a second core network.

20. The method of claim 19 wherein the first core network is one of 4G Core network or 5G Core network and the second core network corresponds to the other one of the 5G core network or 4G core network.

21. The method of claim 15, wherein the admission request further comprises information identifying the operator network.

22. The method of claim 21 wherein the operator network is either a public land mobile network (PLMN) or a Stand-alone Non-Public Network (SNPN) and wherein the information identifying the operator is either a PLMN identifier or an SNPN identifier.

23. (canceled)

24. (canceled)

25. (canceled)
